(19) United States
(12) Patent Application Publication
(10) Pub. No.: US 2007/0090749 A1
(43) Pub. Date: Apr. 26, 2007

(54) IMAGE DISPLAY APPARATUS AND METHOD OF MANUFACTURING THE SAME

(76) Inventors: Nobuo Kawamura, Fukaya-shi (JP); Hitoshi Tabata, Hiratsuka-shi (JP); Isamu Tsuchiya, Takasaki-shi (JP); Takeo Ito, Kumagaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/562,140

(22) Filed: Nov. 21, 2006

Related U.S. Application Data
(63) Continuation of application No. PCT/JP05/11452, filed on Jun. 22, 2005.

(30) Foreign Application Priority Data
Jun. 23, 2004 (JP) 2004-185470

(51) Int. Cl. H01J 63/04; H01J 1/62

(52) U.S. Cl. 313/496

(57) ABSTRACT

A display apparatus in which a light shielding layer to partition fluorescent layers of a fluorescent screen has protrusions and depressions capable of providing a discontinuous area at least with a resistance greater than a predetermined value, for a metal layer for a metal back layer and a metal layer for a getter layer. The height or thickness of a light shielding layer is defined higher than the total thickness of a fluorescent layer, a metal layer for a metal back layer, and a metal layer for a getter layer. According to the present invention, it is possible to effectively manufacture a display apparatus whose picture quality is not degraded by an internal electric discharge. Thus, the cost of the display apparatus is decreased.

### CROSS-REFERENCE TO RELATED APPLICATIONS

This is a Continuation Application of PCT Application No. PCT/JP2005/011452, filed Jun. 22, 2005, which was published under PCT Article 21(2) in Japanese.

This application is based upon and claims the benefit of priority from prior Japanese Patent Application No. 2004-185470, filed Jun. 23, 2004, the entire contents of which are incorporated herein by reference.

### BACKGROUND OF THE INVENTION

1. Field of the Invention

The present invention relates to an image display apparatus and a method of manufacturing the same. More particularly, the invention relates to an image display apparatus which has, in a vacuum housing, electron sources emitting electron beams and a fluorescent screen to display an image, and a method of manufacturing the image display apparatus.

2. Description of the Related Art

A cathode-ray tube (CRT), which is widely used as an image display apparatus, emits an electron beam to fluorescent elements to light the fluorescent elements, and displays an image as a result.

In recent years, there has been developed an image display apparatus provided with many electron-emitting elements (electron source) which selectively emit electron beams to a flat fluorescent screen arranged in a plane and opposed across a predetermined interval, and outputs fluorescence (displays an image). This (plane type) image display apparatus is called a field emission display (FED). In an FED, a display apparatus using a surface transmission emitter as an electron source is classified as a surface transmission type electron emission display (SED). In this application, the term FED is used as a generic name including an SED.

In an FED, the clearance between the substrates of the above-mentioned electron source and fluorescent screen can be set to several millimeters or less. It is known that an FED can be made thinner than a well-known CRT, and can be made light compared with a flat display apparatus such as an LCD. Concerning the picture quality of a display image, an FED is a self-emission type like a CRT and a plasma display, and provides high luminance.

In an FED, image light output from a fluorescent element is reflected to a display surface (a visual surface for an observer), or a face plate, to increase luminance of the image. For this purpose, the FED is provided with a metal back layer, that is, a metal layer to reflect light advancing to an electron source among those output from a fluorescent element by an electron emitted from an electron source. A metal back layer functions as an anode for an electron source, or an emitter.

Further, in the FED, the substrates of electron source and fluorescent screen are opposed with a clearance of several millimeters or less, and the degree of vacuum is held at approximately 10⁻⁴ Pa. It is thus well known that if an internal pressure is increased by gas generated inside, the amount of electron emitted from an electron source is decreased, and the luminance of an image is decreased. Therefore, it is proposed to provide a getter material to absorb the gas generated inside, at a desired position except a fluorescent screen or an image display area.

It is also known that in the construction of the FED, there is a clearance of several millimeters or less between a face plate and a rear plate (in an electron source) having an electron-emitting element, and when a high voltage of approximately 10 kV is applied to the clearance between the two plates, an electric discharge (a vacuum arc discharge) generating a large discharge current reaching 100 A easily occurs.

Jpn. Pat. Appln. KOKAI Publication No. 10-326583 proposes a method of securing a high anode voltage by connecting a common electrode (an anode power supply) to a metal back layer divided into several parts, through a resistor member.

Jpn. Pat. Appln. KOKAI Publication No. 2000-311642 discloses a technology to increase an effective impedance on a fluorescent screen, by forming a zigzag pattern of notches on a metal back layer.

Jpn. Pat. Appln. KOKAI Publication No. 2003-68237 reports an example, in which a metal back layer is divided into several parts, and a getter material is placed among the divided metal backs.

As described in the above applications, it is understandable that an abnormal discharge can be prevented by dividing a metal back layer (and a getter material) functioning as an anode, into an optional number of parts. However, when the size of each pixel on a face plate is assumed to be 0.6 mm in pitch, fluorescent elements of three R, G and B colors which can output light corresponding to the three primary colors are arranged with an interval of several micrometers maximum. The interval is approximately 100 μm with respect to the length direction (the direction extending like a belt) of the fluorescent elements.

Therefore, even if a conventional method, such as vacuum evaporation, CVD or sputtering, is used to give a predetermined shape (to partition) to a getter material (may be a single unit combined with a metal back layer), there arises a problem that a suitable shape (precision) is not obtained due to the precision of a mask material and the accuracy in positioning the mask material and fluorescent element, and an abnormal discharge is not prevented.

In addition, even if a suitable shape can be given to a getter material or a metal back layer combined with a getter material, many steps are required, including a step of arranging three kinds of fluorescent elements on a face plate, a step of forming a light shielding layer as a frame material to partition each fluorescent element on a face plate, a step of forming a getter material to a predetermined thickness on a fluorescent element, and a step of patterning a getter material (or a metal back layer combined with a getter layer) in a predetermined shape. These steps decrease productivity.

### BRIEF SUMMARY OF THE INVENTION

It is an object of the present invention to provide an image display apparatus, which prevents a peak value of a discharge current even if an electric discharge occurs between an electron source and a fluorescent screen, and achieves high productivity, and a method of manufacturing the image display apparatus.

This invention is provided an image display apparatus comprising:

a first substrate which holds an electron beam source;

a second substrate which holds a fluorescent layer to output a predetermined color light by receiving an electron beam output from the electron beam source, and is arranged opposite to the first substrate with a predetermined interval; and

a sidewall which encloses the first substrate and second substrate,

wherein the fluorescent layer has a light shielding layer which is provided on the second substrate, partitions fluorescent elements for each color output from the fluorescent elements, and prevents light output from an optional fluorescent element reaching an adjacent partition;

a plurality of fluorescent area which is provided within a height range of the light shielding layer in a partition surrounded by the light shielding layer, and is capable of emitting a predetermined color light;

a metal layer which is formed in the fluorescent area to cover each of the fluorescent area by being divided by the light shielding layer; and

a gas absorbing material layer which is formed to a predetermined thickness on the metal layer.

Also, this invention is provided a method of manufacturing an image display apparatus, including a step of forming a fluorescent screen formed by laminating a fluorescent layer, a metal back layer to cover a fluorescent layer, and a getter layer; and a step of placing an electron source corresponding to a fluorescent layer, on a rear panel opposite to a face plate; comprising:

forming a light shielding layer made of material including a particle having a shape capable of defining protrusions and depressions in a side not contacting a face plate even after patterning, like a matrix on one plane of a face plate;

forming a fluorescent layer capable of outputting a predetermined color light when receiving an electron beam, in each area partitioned by a light shielding layer, to a predetermined thickness and arrangement related to a thickness of a light shielding layer;

forming a metal layer for a metal back layer to a thickness in all areas including a light shielding layer itself of a fluorescent layer formed in an area partitioned by a light shielding layer, so that a whole thickness including a thickness of a fluorescent layer is equal to or a predetermined height lower than a thickness of a light shielding layer; and

forming a metal layer for a getter layer to a predetermined thickness in all areas including a fluorescent layer formed in an area partitioned by a light shielding layer, a light shielding layer, and a metal back layer, so that a whole thickness including a thickness of a fluorescent layer and a metal back layer is equal to or a predetermined height lower than a thickness of a light shielding layer, in at least a part of an area of a main surface of a phase plate.

### BRIEF DESCRIPTION OF THE SEVERAL VIEWS OF THE DRAWING

FIG. 1 is a perspective view of an FED according to an embodiment of the invention;

FIG. 2 is a sectional view of the FED taken along line A-A of FIG. 1;

FIG. 3 is a plane view of a fluorescent screen and a metal back layer in the FED shown in FIG. 2;

FIG. 4 is a magnified plane view of a fluorescent screen and a light shielding layer of the FED shown in FIG. 2;

FIG. 5 is a sectional view of a fluorescent screen take along line B-B of FIG. 4; and

FIG. 6 is a sectional view of a fluorescent screen take along line C-C of FIG. 4.

### DETAILED DESCRIPTION OF THE INVENTION

Hereinafter, embodiments of the invention will be explained in detail with reference to the accompanying drawings.

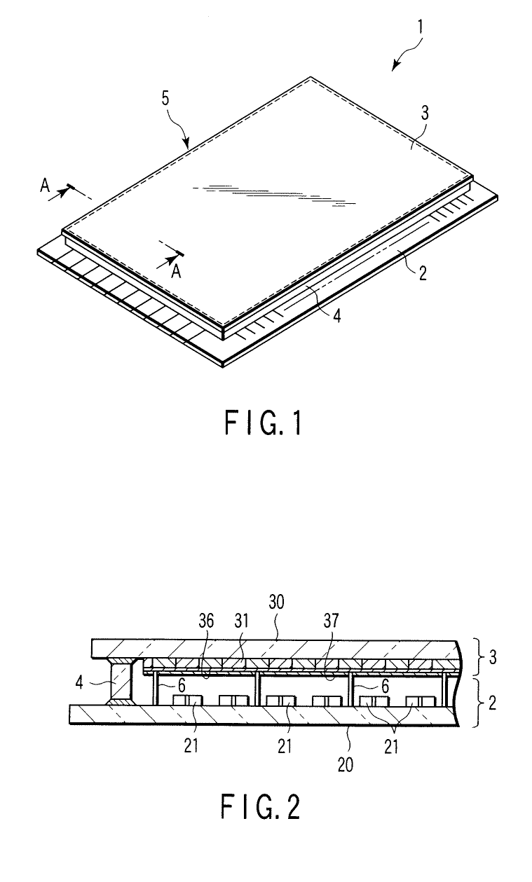

FIG. 1 and FIG. 2 show the structure of a field emission display (FED) according to an embodiment of the invention.

The FED 1 has an electron source substrate 2 having a plurality of electron-emitting elements (electron source) on a plane (a first substrate, called a rear panel hereinafter), and a fluorescent screen substrate which is opposed to the rear panel 2 across a predetermined interval and has a plurality of fluorescent elements in partitions to output fluorescence by receiving electron beams 3 (a second substrate, called a face plate hereinafter).

The rear panel 2 and face plate 3 include a rectangular rear (electron source side) glass base material 20 and a front (fluorescent screen side) glass base material 30 of a predetermined area. In the primary area of the base materials 20 and 30, or in the area corresponding to a display area, there is provided a predetermined number of electron sources (electron-emitting elements) and fluorescent elements (an emitting element) explained hereinafter in FIG. 2.

The substrates 2 and 3, or two glass base materials 20 and 30, are opposed with a gap (interval) of 1-2 mm, and joined by a sidewall 4 (FIG. 2) provided at the peripheries of the substrates 2 and 3. Namely, the FED 1 is constructed as an airtight outer enclosure 5, by the substrates 2, 3 (base materials 20, 30) and sidewall 4. A vacuum of approximately 10⁻⁴ Ps is maintained within the outer enclosure 5.

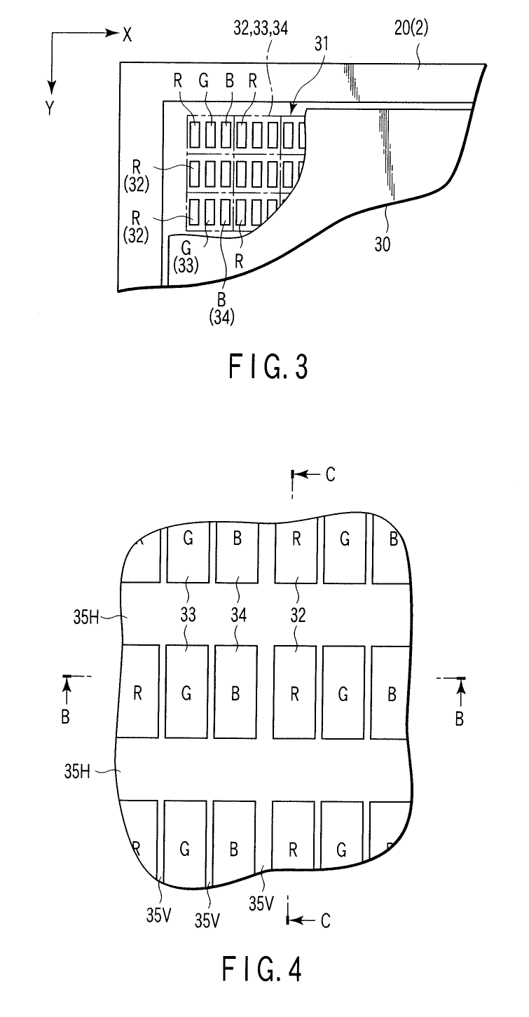

A fluorescent screen 31 is formed on one side of the glass material 30 used for the face plate, or the surface facing the inside when assembled as the outer enclosure 5. As described later in FIG. 3 and FIG. 4, the fluorescent screen 31 has fluorescent layers 32 (R), 33 (G) and 34 (B) formed by three kinds of fluorescent elements to emit red (R), green (G) and blue (B) light, respectively, arranged in a predetermined area, and includes a light shielding layer 35 arranged like a matrix. Each of the fluorescent layer 32 (R), 33 (G) and 34 (B) is formed like a stripe extending in one direction, or as a dot. The light shielding layer 35 is also called a black mask.

Assuming that the longitudinal direction of the face plate 3 (glass base material 30) is a first direction (X-direction) and the width direction orthogonal to the X-direction is a second direction (Y-direction), in the light shielding layer 35, the fluorescent layers R (32), G (33) and B (34) are arranged in 800 lines for example in the first direction X with a predetermined gap (interval). In the second direction, the same color fluorescent layers are arranged in 600 lines for example with a predetermined gap (interval). In each direction, the gap size can be optionally set in a manufacturing error range or in a design fine adjustment range, and is not necessarily a fixed value.

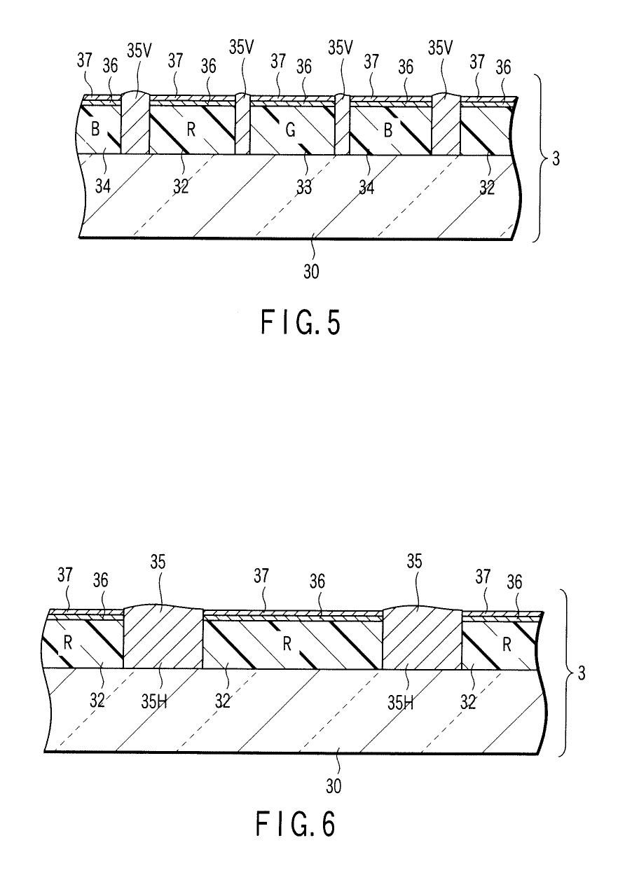

As explained in detail in FIG. 5 and FIG. 6, a metal back layer 36 to function as an anode electrode is formed on the fluorescent screen 31, and in each area (31) partitioned by the light shielding layer 35. In the display operation, a predetermined anode voltage is applied to the metal back layer 36 through a not-shown power supply (a drive circuit). The term “metal back layer” is used in the present invention, but this layer is not limited to metal as long as it functions as an anode, and other various materials can be used.

On one side of the glass base material 20 used in the rear panel 2, or the surface facing to the inside when assembling as the outer enclosure 5, a plurality of electron-emitting element (emitter) 21 to selectively emit an electron beam is provided to excite the fluorescent layers 32, 33 and 34 formed on the fluorescent screen 31 of the face plate 3. The electron-emitting element 21 is arranged in 800 rows×3 and in 600 columns corresponding to each pixel formed on the face plate 3. The electron-emitting element 21 is driven through a matrix wiring connected to a not-shown scanning line driving circuit and signal line driving circuit, or the light shielding layer 35 having optimum resistance.

Between the glass base materials of the rear panel 2 and face plate 3, there is provided a number of spacers 6 formed like a plate or a pole in order to resist atmospheric pressure acting on each base material in the state assembled as the outer enclosure 5.

In the above-mentioned display apparatus 1, an electron beam is emitted from the electron-emitting element 21 in the state that an anode voltage is applied to the metal back layer 36, and the electron beam collided against a corresponding fluorescent layer, and predetermined light (image) is output. Namely, an electron beam from the electron-emitting element (emitter) 21 at Xn_{(R, G, B)}-Ym (n indicates a row, m indicates a column, (R, G, B) indicates a color) selected by a not-shown scanning line driving circuit and signal line driving circuit is accelerated by the anode voltage, and caused to collide against one of the fluorescent layers 32, 33 and 34 of a corresponding pixel. Then, object color light is output from the corresponding fluorescent layer. Therefore, light of a predetermined color is generated for a predetermined time at an optional position, and a color image is displayed in the outside of the glass base material 30 of the face plate 3, or in the visual side.

Next, the characteristics of a light shielding layer will be explained in detail with reference to FIG. 5 and FIG. 6. FIG. 5 and FIG. 6 show cross sections of a fluorescent layer (32, 33, 34) systematically arranged in the X and Y directions as shown in FIG. 4, take along the X and Y directions.

As seen from FIG. 4, the light shielding layer 35 is arranged in 800×3 rows and 600 columns in each of the X (row) and Y (column) directions. In particular, the light shielding layer 35 is divided into a plurality of horizontal line parts 35H extending in the X-direction among the fluorescent layers (same color), and a plurality of vertical line parts 35V among the fluorescent layers (R[32] and G[33], G[33] and B[34], B[34] and R[32]) extending in the Y-direction, in the matrix area which partitions the fluorescent layers 32(R), 33(G) and 34(B) of the fluorescent screen 31.

Assuming that the size of one pixel is 0.6 mm on all sides, for example, concerning the Y-direction in which the fluorescent layer extends like a belt, the thickness of the vertical line part 35V corresponding to the width (X-direction) is narrower than that of the horizontal line part 35H. For example, the width of the vertical line part 35 is 20-100 μm, preferably 40-50 μm, between pixels consisting of R, G and B, that is, B(34) and R(32), and in 20-100 μm, preferably 20-30 μm, between the remaining parts, that is, between R(32) and G(33), or between G(33) and B(34). On the other hand, the width of the horizontal line part 35H is 150-450 μm, preferably 300 μm.

The light shielding layer 35, that is, the horizontal line part 35H and vertical line part 35V, is made of resin material mixed with a predetermined amount of carbon and colored black, for example, which is mixed with a binder material with a predetermined viscosity and a resistance control particle or a metal oxide particle capable of providing a non-flat end-face (an end shape) as shown in FIGS. 5 and 6, in order to prevent undesired leakage (transmission) of light output from a fluorescent layer in an adjacent pixel. As the material used for the light shielding layer 35, any kind of material may be used as long as it includes a metal oxide and resists high-temperature heating such as that in a sealing process.

The mixed-in metal oxide is preferably SiO₂, TiO₂, Al₂O₃, Fe₂O₃, or ZnO. Two or more kinds of metal oxide may be combined. The shape (outside shape) of the metal oxide is a particle of a predetermined size to be obtained by crushing an oxide, preferably a polyhedron having a protrusion projecting in an indefinite direction. It is also permitted to use a substantially spherical metal oxide with an optional number of protrusions or a needle-like portion (a pointed portion).

The outer dimension (maximum) of an metal oxide including a protrusion (a needle-like portion or a pointed portion) is defined to several micrometers to 10 μm, for example.

The light shielding layer 35 including a metal oxide having a protrusion, a needle-like portion or a pointed portion is formed by the well-known photolithograpy. Namely, the light shielding layer 35 is applied to a predetermined thickness on one side of the glass base material 30, preferably remaining unevenness on the surface side that is a free end not contacting the glass base material 30 even at the end of a pattern exposing process and a developing process. The height of the light shielding layer 35, that is, the height viewed from the glass base material 30 is 10 μm, for example. The light shielding layer is formed in the height (thickness) so that the fluorescent material that becomes the fluorescent layers R(32), G(33) and B(34) in a later process equals to or becomes lower (thinner) by a predetermined value than the thickness of the light shielding layer 35.

On each of the fluorescent layers 32, 33, and 34, a layer of not-shown inorganic matter such as an aqua glass or a thin resin (lacquer) layer is formed to a predetermined thickness as a smoothing member. At this time, a condition not to substantially effect a smoothing action is provided in the vertical line part 35V and horizontal line part 35H of the light shielding layer 35. In other words, the vertical line part 35V and horizontal line part 35H of the light shielding layer 35 are given the height (thickness) equal to or lower (thinner) by a predetermined value than the thickness of each of the fluorescent layers 32(R), 33(G) and 34(B), and they can partition the fluorescent layers 32, 33 and 34 formed by a process later than the light shielding layer 35, and can isolate a metal back layer 36 and a getter layer 37 formed on the fluorescent layers 32, 33 and 34. In particular, even if the height of the light shielding layer 35 (the vertical line part 35V and horizontal line part 35H) is substantially equal to the height of each of the fluorescent layers 32, 33 and 34, it is enough for the light shielding layer to isolate the metal back layer 36 and getter layer 37, or to have protrusions and depressions on the surface. (The height of the light shielding layer 35 equals the height of the fluorescent layer.) Further, even if the height of the light shielding layer 35 is lower than the fluorescent layer, the height can be optionally set as long as the light shielding layer can isolate the fluorescent layers 32, 33, 34, metal back layer 36 and getter layer 37. Here, the word “isolate” is used to mean electrical continuity is prevented. However, generally, even an insulator does not have an infinite resistance, and is not electrically isolated in the strict sense. Therefore, in this application, a state wherein the resistance is increased extremely in a non-continuous film compared with the resistance in a continuous film is expressed as electrical isolation.

The light shielding layer 35 having protrusions and depressions on the surface is suitable for isolating the metal back layer 36 and getter layer 37, but the layer itself is formed in matrix as one unit. Thus, when a discharge occurs between substrates, a predetermined resistance is necessary to restrict the degree of discharge current prodeced by the discharge. Therefore, the resistance of the light shielding layer 35 is preferably set to 10³ Ω/□ or higher by optimizing a conductivity (resistivity) peculiar to a metal oxide used for the light shielding layer 35, or a mixing ratio with a binder material. Contrarily, if the resistance is too high, brightness or luminance of a display image is lowered extremely. It is thus preferable to set the resistance to a maximum of 10⁸ Ω/□.

Next, a brief explanation will be given on an example of a process of manufacturing the above-mentioned fluorescent screen.

First, form a not-shown base of a processing agent to a predetermined thickness on one side of the glass substrate 30 used for the face plate 3, and form a predetermined pattern of the light shielding layer 35 made of black pigment (carbon) by lithography. The light shielding pattern 35 is given a pattern of the vertical line part 35V and horizontal line pattern 35H arranged like a matrix.

Then, apply a fluorescent solution of ZnS group, Y₂O₃ group, or Y₃O₂S group to each display area (light-emitting space) partitioned by the vertical line part 35V and horizontal line part 35H, by a slurry method. Dry the applied solution, pattern by photolithography, and form fluorescent layers 32, 33 and 34 of three colors Red (R), Green (G) and Blue (B). Each color fluorescent layer can also be formed by a spray method or a screen printing method. Of course, patterning by photolithography may be used as needed in a spray method or a screen printing method.

Then, form a not-shown flat smoothing layer made of inorganic material such as aqua glass on the fluorescent screen 31, or the fluorescent layers 32, 33 and 33, by a spray method. Form the metal back layer 36 made of metallic film such as aluminum (Al) by vacuum evaporation, CVD or sputtering. According to the principle explained before, the metal back layer 36 is divided for each partition (display area) of fluorescent layers 32, 33 and 34 by the vertical line part 35V and horizontal line part 35H of the light shielding layer 35.

Thereafter, insert the face plate 3 having the fluorescent screen 31 formed thereon and the rear plate 2 having a plurality of electron source (electron-emitting element) 21 arranged thereon, into a vacuum unit, and enclose the face plate 3 and rear panel 2 under a predetermined decreased pressure (in vacuum). Generally, the getter layer 37 loses the effect when exposed to atmosphere, and is formed by keeping the space between the phase plate 3 and rear panel 2 vacuum.

Then, although not described in detail, the FED 1 is formed by connecting a not-shown power supply unit for an anode, a scanning line driving circuit, and signal line driving circuit.

In the FED configured as described above, the metal back layer 36 as a conductive thin film is partitioned (isolated) electrically discontiguous by the light shielding layer 35. Therefore, even if an electric discharge occurs between the phase plate 3 and rear panel 1, a peak value of a discharge current can be sufficiently controlled, and a damage caused by a discharge can be avoided.

In the embodiment described above, the protrusion and depression of the light shielding layer 35 are provided in all rows and columns of a matrix. However, the vertical line part 35V may be provided only between B and R (a side space portion) when R, G and B are collectively taken as one pixel.

Further, by forming the metal back layer 36 and getter layer 37 on the fluorescent screen 31 including the light shielding layer 35 formed uneven on the surface, by a vacuum film forming process, the metal back layer 36 and getter layer 37 including an electrically isolated area can be collectively formed on substantially the whole surface of the fluorescent screen 31 by one process. This makes it possible to manufacture an image display apparatus at a low cost, which is not damaged by an electric discharge.

As explained hereinbefore, according to the invention, a metal back layer and a getter material on a fluorescent screen can be securely isolated electrically without increasing the number of processes. Further, even if a discharge occurs, a peak value of a discharge current can be controlled, preventing breakage, damage and deterioration of an electron-emitting element and a fluorescent screen.

The invention is not limited to the aforementioned embodiments. Various modifications and variations are possible in a practical stage without departing from its essential characteristics. Each embodiment may be appropriately combined as far as possible. In such a case, the effect by the combination is obtained.

According to the present invention, fluorescent elements of R, G and B arranged in a predetermined sequence are partitioned by a light shielding layer formed on a substrate before the fluorescent elements are arranged, and arranged in a predetermined area on the substrate. A light shielding layer is given a predetermined resistance, and prevents a metal layer and a getter material formed on a fluorescent element in a later process from becoming a continuous surface along the surface of the fluorescent element indicating electrical continuity.

Therefore, it is possible to effectively manufacture a display apparatus whose picture quality is not degraded by an internal electric discharge. This decreases the cost of the display apparatus.

What is claimed is:

1. An image display apparatus comprising:
a first substrate which holds an electron beam source;
a second substrate arranged opposite to the first substrate with a predetermined interval which holds a fluorescent layer to output a predetermined color light by receiving an electron beam output from the electron beam source, and the fluorescent layer has a light shielding layer which is provided on the second substrate, partitions fluorescent elements for each color output from the fluorescent elements, and prevents light output from an optional fluorescent element reaching an adjacent partition; and
a sidewall which encloses the first substrate and second substrate,
a plurality of fluorescent area which is provided within a height range of the light shielding layer in a partition surrounded by the light shielding layer, and is capable of emitting a predetermined color light;
a metal layer which is formed in the fluorescent area to cover each of the fluorescent area by being divided by the light shielding layer; and
a gas absorbing material layer which is formed to a predetermined thickness on the metal layer.

2. The image display apparatus according to claim 1, wherein the light shielding layer is formed with protrusions and depressions at an end opposite to and not contacting the second substrate.

3. The image display apparatus according to claim 1, wherein the protrusions and depressions of the light shielding layer are formed by protrusions to define an outside shape of a metal oxide particle included in the material used for the light shielding layer.

4. The image display apparatus according to claim 1, wherein the height of the light shielding layer from the second substrate is defined equal to the total thickness of the fluorescent area, metal layer and gas absorbing material layer, or to a predetermined height to the second substrate, in at least a part of an area in the face direction of the second substrate.

5. The image display apparatus according to claim 2, wherein the light shielding layer includes a fine particle of at least a kind of metal oxide selected from SiO₂, TiO₂, Al₂O₃, Fe₂O₃, and ZnO.

6. The image display apparatus according to claim 2, wherein the light shielding layer has a predetermined resistance.

7. The image display apparatus according to claim 1, wherein the electron source is composed of a plurality of electron-emitting elements provided like a matrix on the first substrate.

8. A method of manufacturing an image display apparatus, including a fluorescent screen formed by laminating a fluorescent layer, a metal back layer to cover a fluorescent layer, and a getter layer; and placing an electron source corresponding to a fluorescent layer, on a rear panel opposite to a face plate; the method comprising:
forming a light shielding layer made of material including a particle having a shape capable of defining protrusions and depressions in a side not contacting a face plate even after patterning, like a matrix on one plane of a face plate;
forming a fluorescent layer capable of outputting a predetermined color light when receiving an electron beam, in each area partitioned by a light shielding layer, to a predetermined thickness and arrangement related to a thickness of a light shielding layer;
forming a metal layer for a metal back layer to a thickness in all areas including a light shielding layer itself of a fluorescent layer formed in an area partitioned by a light shielding layer, so that a whole thickness including a thickness of a fluorescent layer is equal to or a predetermined height lower than a thickness of a light shielding layer; and
forming a metal layer for a getter layer to a predetermined thickness in all areas including a fluorescent layer formed in an area partitioned by a light shielding layer, a light shielding layer, and a metal back layer, so that a whole thickness including a thickness of a fluorescent layer and a metal back layer is equal to or a predetermined height lower than a thickness of a light shielding layer, in at least a part of an area of a main surface of a phase plate.

9. The method of manufacturing an image display apparatus according to claim 8, wherein a light shielding layer has protrusions and depressions defined at the open end side in the thickness direction, and the protrusions and depressions are formed by protrusions to define an outside shape of a metal oxide particle included in the material used for the light shielding layer.

10. The method of manufacturing an image display apparatus according to claim 8, wherein a light shielding layer provides a discontinuous area at least with a resistance greater than a predetermined value, for a metal layer for a metal back layer and a metal layer for a getter layer.

11. The method of manufacturing an image display apparatus according to claim 8, wherein a light shielding layer includes a fine particle of at least a kind of metal oxide selected from SiO₂, TiO₂, Al₂O₃, Fe₂O₃, and ZnO.

12. The method of manufacturing an image display apparatus according to claim 8, wherein a light shielding layer has a predetermined resistance.
